(19) United States
(12) Patent Application Publication
(10) Pub. No.: US 2026/0324625 A1
(43) Pub. Date: Oct. 22, 2026

(54) METHODS AND SYSTEMS FOR PRESERVING AND MONITORING ORGANS, CELLS AND TISSUES

(71) Applicants: PROCYON TECHNOLOGIES LLC, Tucson, AZ (US); ARIZONA BOARD OF REGENTS ON BEHALF OF THE UNIVERSITY OF ARIZONA, Tucson, AZ (US)

(72) Inventors: Klearchos PAPAS, Tucson, AZ (US); Robert C. JOHNSON, Estes Park, CO (US)

(73) Assignee: ARIZONA BOARD OF REGENTS ON BEHALF OF THE UNIVERSITY OF ARIZONA, Tucson, AZ (US)

(21) Appl. No.: 19/486,785

(22) PCT Filed: May 21, 2024
(86) PCT No.: PCT/US2024/030322

§ 371 Date: Nov. 21, 2025

Related U.S. Application Data
(60) Provisional application No. 63/468,191, filed on May 22, 2023.

(51) Int. Cl. A01N 1/143; A01N 1/144

(52) U.S. Cl. CPC A01N 1/143; A01N 1/144

(57) ABSTRACT

Methods and systems of preserving, treating and monitoring organs, tissues and implants are provided. In some embodiments, systems are provided that comprises a closed terminus and a substantially sealed system and wherein a parameter is detected in order to selectively control a flow of fluid to the system. Methods and system for preserving organs are provided with reduced material needs, improved energy efficiencies, and enhanced organ preservation are provided.

### CROSS-REFERENCE TO RELATED APPLICATIONS

This International Application claims the benefit of priority of U.S. Provisional Patent Application Ser. No. 63/468,191, filed May 22, 2023, the entire disclosure of which is hereby incorporated by reference.

### FIELD

Embodiments of the present disclosure relate to methods and systems for preservation and management of cells, tissues, and organs. In some embodiments, methods and systems include membranes, temperature regulation, oxygen and nutrient delivery, and sensing systems for preservation. Certain embodiments contemplate improved delivery and monitoring of molecules and gases to cells and tissues, and intermittent automated delivery of fluids to tissue(s).

### BACKGROUND

Preservation of organs and tissues ex vivo is a critical aspect of healthcare and life sciences with life-and-death implications. Advancements in surgery and medicine have enabled the transplantation of organs and tissues between hosts. However, the practical realities and logistics of organ transplantation and preservation provide significant obstacles, time constraints, and expenses particularly when an organ or tissue becomes available suddenly and must be transported to a recipient.

Known systems and methods of organ preservation including, for example, U.S. Pat. No. 10,091,985 to Tempelman et al. which is hereby incorporated by reference in its entirety, contemplate the handling and preservation of organs ex vivo. Such devices and systems generally require large fluid storage means (e.g. oxygen gas supplies), power demands, and associated equipment that render transport difficult.

### SUMMARY

It is an object of the present disclosure to provide methods and systems for organ and tissue preservation. Methods and systems of the present disclosure provide for enhanced systems at least in that the present disclosure provides for enhanced power usage and management, reduced resource requirements (e.g. reduced gas consumption requirements), and allows organs and tissues to be preserved for longer periods of time with few resources. The present disclosure contemplates improved systems and enhanced efficiencies and are applicable in various applications including, but not limited, laboratory research settings, emergency medical operations and related transport operations.

Existing methods of handling and preserving organs and tissue include, for example, static cold storage systems wherein blood is flushed from an organ and the organ is stored at cold temperature(s) (e.g. 0-4 Celsius). Fluid and blood may be removed from the organ under pressure. Methods and systems for persufflation or gaseous oxygen perfusion are also known wherein an organ is provided and a supply of oxygen or oxygenated gas is delivered to the organ. The organ is contemplated as being housed, cooled and preserved in a similar manner as in a static cold storage arrangement. However, oxygen is provided to support the organ. The oxygen is generally vented to the atmosphere by one or more of a pressure relief valve and an air vent. It is contemplated that a continuous or near continuous supply of oxygen is provided to the organ. Additional known methods and systems of machine perfusion in a hypothermic or normothermic state comprise fluid (e.g. oxygen or oxygenated gas) that is pumped to an organ. The fluid may be recirculated under pressure and/or cooled by a cooling element. Such systems contemplate a supplemental supply of oxygen to maintain or prolong the viability of the organ and its useful life. Known systems, however, require significant amounts of tooling, equipment, and fluid (e.g. oxygen) supply. While such systems have been shown to extend the useful life of an organ as needed for transportation and transplantation, the systems are limited in various respects including, for example, portability, safety, and efficacy. Accordingly, there exists a long-felt and unmet need to provide a system for organ and tissue preservation that provides resources to an organ (for example) and extends the useful life of the organ while also providing a safe, convenient, and portable system and method. Embodiments of the present disclosure contemplate improved methods and systems in accordance with those needs.

Embodiments of the present disclosure relate to systems and methods for preserving and maintaining the viability of tissue and organs. Certain embodiments of the present disclosure provide a system and related methods of use wherein tissue(s) including, for example, an organ to be preserved are provided within or in combination with a system that comprises a gas delivery system including, for example, an oxygen delivery system, a cooling system, and a control system including (in some embodiments) a pressure control system to automatically regulate gas delivery.

In certain embodiments, a containment vessel is provided for receiving an organ or tissues. The containment vessel is contemplated as comprising a cooling system to control a temperature of the organ or tissues contained within the system. For example, in some embodiments, a substrate is provided in proximity to an organ or tissue and in a manner that allows for thermal energy transfer with the organ or tissue. In one embodiment, a substrate is provided that comprises gas tubing and which acts as a heat exchanger. The gas tubing is contemplated as receiving and transferring a fluid to the organ or tissue. In some embodiments, the gas is cooled to a temperature of between approximately 0 and 15 degrees Celsius and preferably to a temperature of between approximately 4 and 8 degrees Celsius. Thermal management is provided to assist in organ preservation and reduce the metabolic rate of the organ or tissue to be preserved. The specific temperature at which the organ and/or system is held may vary based on the specific organ or tissue as will be understood by one of ordinary skill in the art. System of the present disclosure also contemplate the temperature control and thermal management of the fluid being provided to the system. It is contemplated that an oxygenated gas, for example, is cooled to a desired temperature prior to delivery to the organ(s) or tissue(s).

In one embodiment, a system for maintaining and preserving at least one of an organ, a tissue and an implantable therapeutic device is provided wherein the system comprises a fluid delivery system comprising a fluid source and a fluid conduit. A fluid conduit supplies fluid to at least one of an organ, a tissue, and an implantable therapeutic device. The fluid conduit extends from the at least one of an organ, a tissue, and an implantable therapeutic device and comprises a closed terminus or “dead-end” such that fluid is contained.

A pressure sensor is preferably provided that is operable to determine a pressure and a controller is preferably provided that is operable to terminate fluid delivery from the fluid delivery system when the pressure determined by the pressure sensor is equal to or greater than a predetermined value.

In various embodiments, methods of preserving organs and tissues are provided. In one embodiment, a method of preserving at least one organ ex vivo is provided that comprises the steps of providing at least one organ with a flow of fluid and wherein the fluid comprises oxygen. At least one of pressure and oxygen concentration in the system is monitored and/or evaluated. A flow of fluid is selectively activated and deactivated based on the at least one of pressure and oxygen concentration.

International Application Nos. PCT/US2017/060036 to Papas, PCT/US2017/060034 to Papas, PCT/US2017/060041 to Papas, and PCT/US2017/060043 to Papas relate to encapsulation devices and are each incorporated by reference in their entireties herein for all purposes.

Devices of the present disclosure comprise various materials, including those deemed appropriate by a person skilled in the art for an implantable medical device. For example, membranes of the present disclosure are contemplated as being prepared from a polymeric material. In such embodiments, the single layer gradient membrane is prepared from such polymeric materials as: polysulfone, polyarylethersulfone (PAES), polyethersulfone (PES), cellulose ester (cellulose acetate, cellulose triacetate, cellulose nitrate), nanocellulose, regenerated cellulose (RC), silicone, polyamide (nylon), polyimide, polyamide imide, polyamide urea, polycarbonate, ceramic, titanium oxide, aluminum oxide, silicon, zeolite (alumosilicate), polyarylonitrile (PAN), polyethylene (PE), low density polyethylene (LDPE), polypropylene (PP), polytetrafluoroethylene (PTFE), polyvinylidene fluoride (PVDF), polyvinylchloride (PVC), polypiperazine amide, polyethylene terephthalate (PET), polycarbonate (PC), polyurethane, and any complex or mixtures thereof. In particular embodiments, a single layer gradient membrane comprises a polymeric material comprising polytetrafluoroethylene (PTFE). In certain preferred embodiments, PTFE is provided for at least a vascularizing layer of devices of the present disclosure. Additional materials are contemplated as being provided in membranes and implants of the present disclosure in addition to or in lieu of PTFE.

In various embodiments, it is contemplated that one or more membranes or layers of devices of the present disclosure comprise biodegradable features. For example, in some embodiments, vascularization membranes as disclosed herein are contemplated comprising a biodegradable feature such as disclosed and described in European Patent EP3413941 to Greenwood which is hereby incorporated by reference in its entirety. Additionally, biocompatible or biodegradable polymers such as those shown and described in WO/2008/014561 to Gunatillake et al., WO/2009/043099 to Moore et al., WO/2005/089778 to Adhikari et al., WO/2004/009227 to Adhikari et al., and WO/2005/085312 to Adhikari et al. are contemplated for use in embodiments and devices of the present disclosure and are all hereby incorporated by reference in their entireties.

Various concepts disclosed herein may be provided in combination with one another even if such combination is not specifically depicted or described.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In addition, the materials, methods, and examples are illustrative only and are not intended to be necessarily limiting.

### DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure and is not meant to limit the inventive concepts disclosed herein.

The accompanying drawings, which are incorporated in and constitute a part of the specification, illustrate embodiments of the disclosure and together with the general description of the disclosure given above and the detailed description of the drawings given below, serve to explain the principles of the disclosure.

FIG. 1 is a schematic of a system for organ and tissue preservation according to one embodiment of the present disclosure.

FIG. 2 is a schematic view of a preservation and perfusion system according to an embodiment of the present disclosure.

FIG. 3 is a schematic view of an implantable encapsulation device and related support system according to an embodiment of the present disclosure.

FIG. 4 a view of an implantable system according to one embodiment of the present disclosure.

FIG. 5 is an illustration of a system for preserving and maintaining an implantable device according to one embodiment of the present disclosure.

FIG. 5 is a schematic of an organ and tissue preservation system according to an embodiment of the present disclosure.

FIG. 6 is a schematic of a preservation system according to an embodiment of the present disclosure.

FIG. 8 is a schematic of a preservation and wound treatment system according to an embodiment of the present disclosure.

FIG. 9 is an illustration of a subcutaneous system for sensing and therapeutic treatments according to one embodiment of the present disclosure.

FIG. 10 is a cross-sectional elevation view of the embodiment of FIG. 19.

FIG. 11 is an illustration of an implantable sensor system according to an embodiment of the present disclosure.

FIG. 12 is an illustration of an implantable sensor system according to an embodiment of the present disclosure.

The drawings are not necessarily to scale. In certain instances, details that are not necessary for an understanding of the disclosure or that render other details difficult to perceive may have been omitted. It should be understood, of course, that the disclosure is not necessarily limited to the particular embodiments illustrated herein.

### DETAILED DESCRIPTION

Reference to an element by the indefinite article “a” or “an” does not exclude the possibility that more than one element is present, unless the context clearly requires that there be one and only one element. The indefinite article “a” or “an” thus usually means “at least one.”

As used herein, “about” means within a statistically meaningful range of a value or values such as a stated concentration, length, molecular weight, pH, sequence identity, time frame, temperature or volume. Such a value or range can be within an order of magnitude, typically within 20%, more typically within 10%, and even more typically within 5% of a given value or range. The allowable variation encompassed by “about” will depend upon the particular system under study, and can be readily appreciated by one of skill in the art.

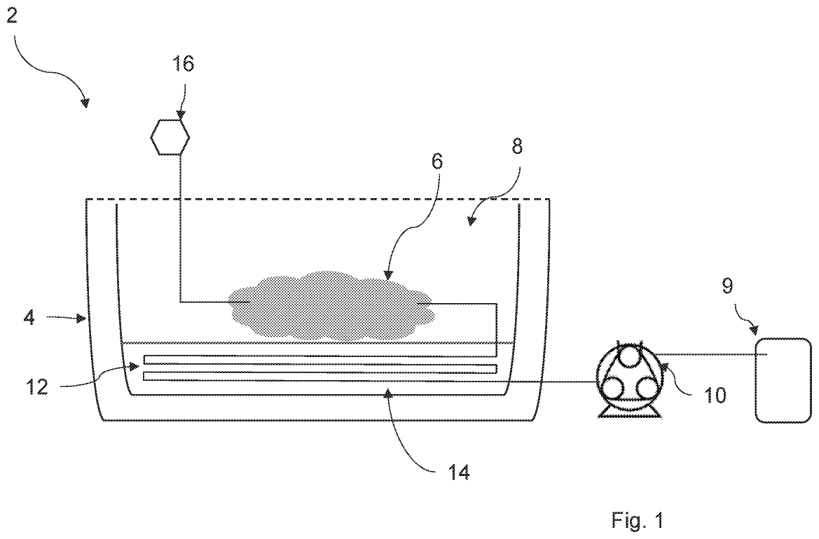

FIG. 1 is a schematic of a system 2 according to an embodiment of the present disclosure. As shown, the system 2 comprises an organ and tissue preservation system. Various features, devices, and components of the system shown in FIG. 1 may be provided in alternative embodiment and/or in isolation and the embodiments of the present disclosure are not limited to the arrangement and collection of features shown in FIG. 1. The system 2 is contemplated as comprising a containment vessel 4 for one or more organs or tissue(s). The containment vessel is contemplated as comprising various sizes and shapes and no limitation with respect to size, shape, material, etc. is provided. In some embodiments, it is contemplated that the vessel 4 comprises an insulated or partially insulated vessel to maintain and control temperature within the vessel. For example, the vessel is contemplated as comprising a double-walled container with insulative material (e.g. foam, argon gas) between the walls. The space between the walls is also contemplated as being under vacuum pressure to enhance insulation.

In various embodiments of the present disclosure, oxygen is delivered directly to the vasculature of the organ 6 or tissue to be preserved. For example, oxygen or oxygenated gas is contemplated as being provided in one or more conduits that are fluidly connected to one or more blood vessels of an organ or tissue to be preserved by a cannula, luer, and/or devices that will be recognized by one of ordinary skill in the art for such purposes. Alternatively or in addition to such features, gas is contemplated as being provided to a volume in which an organ or tissue is to be preserved and oxygen (for example) is absorbed by the organ or tissue. Regardless of these particular arrangements, embodiments of the present disclosure contemplate cycling oxygen delivery in manner that increases efficiencies and as shown and described herein.

The vessel 4 may comprise various sizes. In some embodiments, the vessel comprises an internal volume of between approximately 0.25 cubic feet and 5 cubic feet. The total volume is contemplated as being slightly larger based on sidewall thickness and other factors. In preferred embodiments, the vessel 4 is contemplated as being operable to house and contain an organ such as a pancreas, a kidney, a heart, a lung, and other animal (including but not limited to human) organs. The intended use is contemplated as providing the motivation and need for certain sizes and volumes of the device 4.

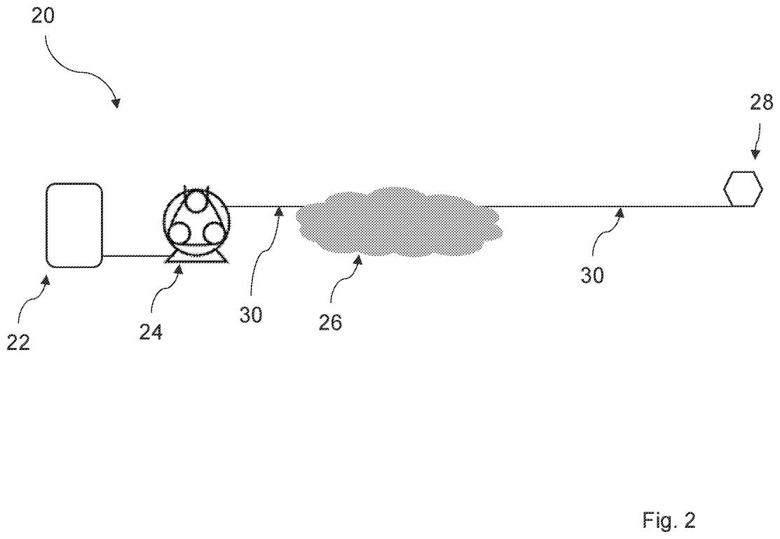

Systems and methods of the present disclosure contemplate gas delivery in organ and tissue preservation. As shown in FIG. 1, the system 2 comprises a gas delivery system comprising a gas source 9 and a pump 10. The pump 10 is contemplated as comprising a peristaltic pump, but other pumps as known to one of ordinary skill in the art are also contemplated and useful with embodiments of the present disclosure. The pump 10 is operable to deliver gas including but not limited to oxygen from the source 9 to the vasculature of an organ 6 provided within the system 2. In some embodiments, including that shown in FIG. 2, a gas conduit 12 is provided that routes or conveys gas from the source and the pump to the organ 6. The gas conduit 12 extends through a cooling or cooled region 14 of the vessel. The conduit 12 comprises a serpentine configuration and/or numerous passes through the cooled region 14 to maximize surface area and enhance heat exchange. Once cooled, the gas is delivered to the interior volume 8 of the container 4 and/or directly to the organ 6 and its vasculature. The gas tubing is contemplated as receiving and transferring a fluid to the organ or tissue. In some embodiments, the gas is cooled to a temperature of between approximately 0 and 15 degrees Celsius and preferably to a temperature of between approximately 4 and 8 degrees Celsius.

The system further comprises a pressure sensor 16. As shown, the gas delivery system and gas conduit 12 terminates at the pressure sensor 16. A flow of gas is therefore not recirculated as in known systems. A terminus or “dead end” is provided and a pressure sensor 16 is provided at or proximal to the terminus. The sensor 16 is contemplated as comprising a pressure sensor to determine when a sufficient pressure and/or oxygen concentration has been provided within the containment vessel 4 and/or the organ 6. In preferred embodiments, the sensor 16 is in communication with the pump 10 (via a controller, for example) to control delivery of gas to the system. For example, when the pressure reaches or exceeds a predetermined level known to be associated with sufficient oxygen provision to the organ, the system 2 is operable to deactivate the pump 10 thereby saving power, reducing the need for large batteries or other power sources, and conserving oxygen in a manner that enables a smaller, more portable, and safer preservation system. Similarly, the system is operable to activate the pump 10 and provide oxygen delivery to the vessel 4 and organ 6 when a pressure detected at the sensor 16 is less than a predetermined value. Accordingly, the system provides for selective delivery of gas on an as-needed basis and provides a more efficient system.

Known systems generally rely on a nearly unlimited supplies of power and gas. For example, in a laboratory setting or medical facility, a municipal power supply and large-scale gas storage are often provided. Such systems are generally not scalable in a manner that enables transportation. It is impractical, unsafe, or impossible to transport organs in such related systems particularly on airlines and other means that are often relied on for quickly transporting vital organs and tissues great distances in short amounts of time. Embodiments of the present disclosure provide a novel system and methods of preserving and transporting organs and tissues in a manner that is portable and energy-efficient based on at least the pressure sensing and pump cycling features as shown and described herein.

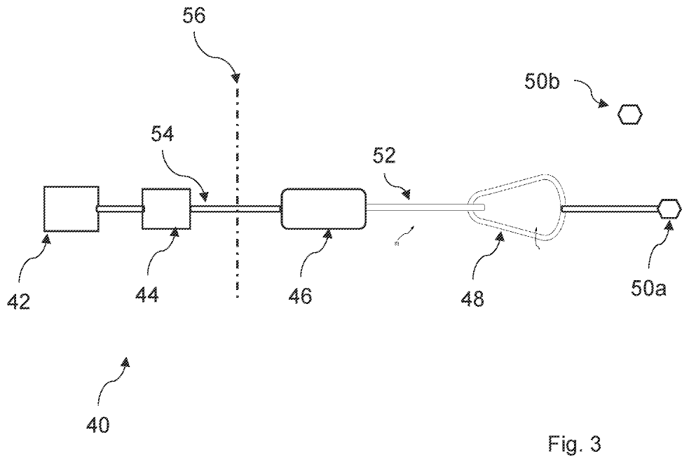

FIG. 2 is a schematic of an improved perfusion system according to one embodiment of the present disclosure. The system 20 of FIG. 3 is operable to provide gas or liquid and preserve an organ, tissue or similar material. Although certain embodiments of the present disclosure are operable to preserve organs and/or tissue and well suited for such applications, the present disclosure is not limited to such intended uses. For example, it is contemplated that certain features of the present disclosure are useful with operation and preservation of implantable encapsulation devices including, for example, those shown and described in U.S. Provisional Patent Application Ser. No. 63/337,449, filed May 2, 2022, U.S. Patent Application Publication Nos. 2019/0328289, 2020/0281709, 2020/0063085, 2020/0054257, 2021/0401564, and 2022/0134074, which are all hereby incorporated by reference in their entireties and for all purposes.

As shown in FIG. 2, a fluid supply 22 and a pump 24 are provided. The fluid supply, which may comprise oxygen gas, is operable to be delivered to an organ 26 (for example) by the pump 24. A pressure sensor 28 is provided a terminus of the gas supply line 30. The pressure sensor is operable to determine a pressure and, in some embodiments, a related oxygen concentration in the system and selectively activate and deactivate the delivery of fluid from the supply 22. The pressure values that determine when fluid flow is to be activated and terminated are contemplated as varying based on the type of organ, tissue, or device provided with the system. For example, a pancreas is contemplated a certain activation and deactivation levels while a vascularized cell encapsulation device, a kidney, etc. may require the provision and cessation of fluid (e.g. oxygen) at different levels.

As opposed to known systems of continuous fluid supply and perfusion, embodiments of the present disclosure contemplate the provision of fluid including, for example, oxygen or oxygen-containing gas in a controlled manner as shown and described herein. In some embodiments, methods of organ preservation and fluid delivery are contemplated. Methods of the present disclosure contemplate providing fluid to a system and/or organ and wherein a flow of the fluid is selectively activated and deactivated based on predetermined parameters. For example, it is contemplated that a pressure value within the system is a parameter by which fluid delivery is determined and controlled. It is contemplated that minimum and maximum pressures are provided and the system is operable to activate fluid flow (via a pump, for example) when a pressure is below a predetermined minimum and the system is operable to deactivate the fluid flow when the pressure is above a predetermined maximum. The predetermined pressure values may vary based on the intended application (the organ to be preserved, for example). In some embodiments, systems and methods are operable to activate a flow of oxygen from an oxygen source to an organ or organ-containing vessel when a pressure in the system is at or below approximately 13.0 PSI. The system is operable to terminate a flow of fluid or oxygen when the pressure in the system is at or above approximately 14.5 PSI. In preferred embodiments, a predetermined range in which pressure is maintained comprise a range of between 13.5 and 14.5 PSI. In some embodiments, this pressure range comprises a range of between approximately 13.8 PSI and 14.5 PSI and more preferably of about 13.8 and 14.2 PSI.

In addition to and/or in lieu of pressure monitoring and related fluid flow control features, embodiments of the present disclosure further contemplate the sensing, monitoring and control of additional parameters including, for example, in-line oxygen levels and oxygen levels in particular portions or regions of the system (e.g. within a cell chamber). As with pressure levels, preferred levels and ranges for oxygen levels may be set or determined based on a particular application. In some embodiments, for example, oxygen levels are maintained within a fluid flow line between approximately 30% and 60%, and more preferably between approximately 39% and 45% oxygen. Oxygen concentration is contemplated as being controlled by cycling a pump on and off and/or selectively venting the system. Oxygen is contemplated as being determined at one or more locations in the system by the provision of one or more oxygen sensors including, for example, a commercially available in-line oxygen sensor from PYROSCIENCE™ or PROFUSA™.

In some embodiments, an oxygen concentration in a cell chamber is maintained in a range of between approximately 300 and 800 micromolar (μM). More preferably, the oxygen concentration is maintained in a range of between approximately 400 and 700 μM. In preferred embodiments, the oxygen concentration is maintained in a range of between approximately 450 and 650 μM. These values and ranges may vary based on intended applications including, for example, the particular cells and tissues to be preserved.

As shown in FIGS. 1-2, a fluid supply line is provided that terminates at a dead-end. Such systems generally comprise closed, non-looping and non-venting systems wherein fluid is provided from a source to an organ (for example). The closed system allows more measurement of pressure (for example) at a terminus with a sensor 28. Systems of the present disclosure provide for strategic placement of the terminus and sensor 28. For example, while it is contemplated that the sensor 28 of FIG. 3 could be placed in various locations including, for example, within or proximal to the organ 26, the conduit 30 of the present disclosure enables the terminus to be placed in various locations including external to the organ 26, external to a containment vessel (4 of FIG. 1, for example), or proximal to the surface of a patient's skin. For example, certain embodiments of the present disclosure contemplate a system that is subcutaneously implantable in a patient and wherein an implantable encapsulation device is provided. Sensors, including pressure sensors, may be provided within the encapsulation device. However, in such arrangements, data from the sensor may not be readable based on the type of sensor used and/or the depth of implantation of the device. Embodiments of the present disclosure provide the ability to locate one or more sensors external to the device and proximal to the patient's skin. In such embodiments, the sensor and related channel comprise substantially the same pressure value(s) as provided at or in the encapsulation device but the means for determining or detecting the pressure values (and related conditions) is strategically located and locatable based on specific conditions, user preferences, etc.

In various embodiments, including those shown in FIGS. 1 and 2, organ preservation is enabled and achieved by the provision of gas perfusion wherein gas is provided to the vasculature of an organ or similar tissue or device that is to be preserved or oxygenated.

Sensors of the present disclosure including, for example, the pressure sensor 28 of the system of FIG. 2 are contemplated as comprising various different types of sensors. For example, it is contemplated that sensors of the present disclosure comprise one or more of optical sensors and nuclear magnetic resonance (“NMR”) sensors. In some embodiments, a combination of a optical and NMR sensors are provided. The sensor(s) are contemplated as being encased in gas-permeable silicone.

The fluid supply of various embodiments, including the fluid supply 22 of FIG. 2 is intended to be non-limiting. Such features are contemplated as comprising stored gas (e.g. oxygen), a supply of ambient air, a gas generator (e.g. oxygen generator), and various combinations thereof.

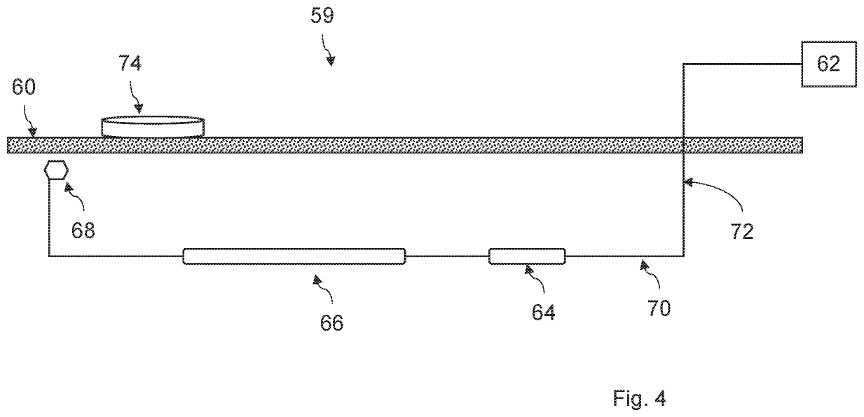

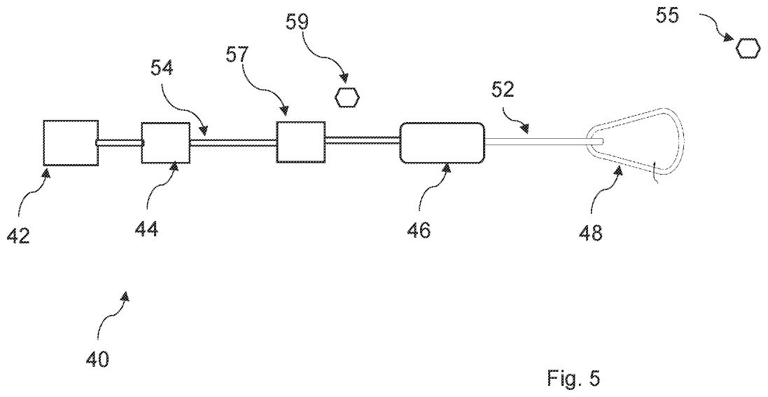

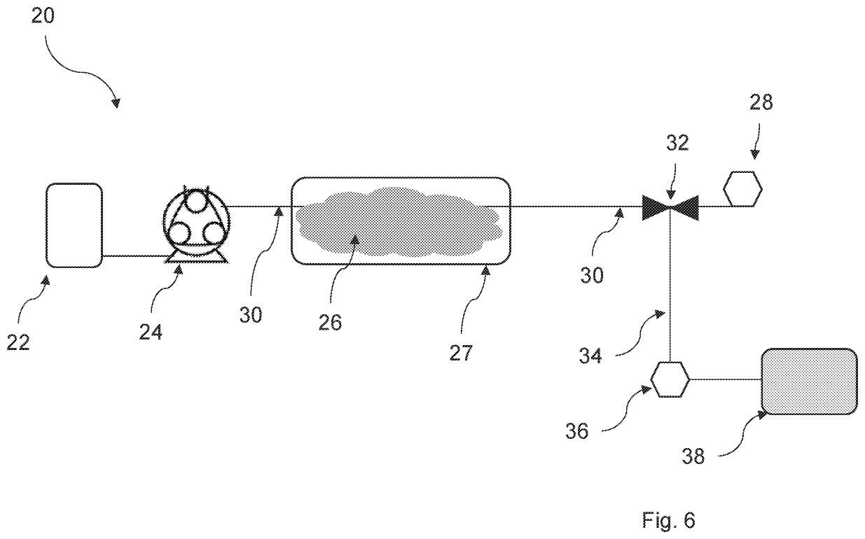

FIG. 3 is a schematic view of a system according to another embodiment of the present disclosure. As shown, the system 40 comprises a fluid source 42. The fluid source is contemplated as comprising one or more of stored gas (e.g. oxygen) and an oxygen generator. The fluid source 42 is in fluid communication with a diffuser 44. A diffuser 44 is provided in various embodiments and enables control of oxygen levels to be delivered to other components of the system. For example, it is contemplated that one or more oxygen diffusers are provided to reduce the amount or concentration of oxygen in a fluid from the source 42. Diffusers of the present disclosure including but not limited to those shown in FIGS. 4 and 5 are contemplated as comprising silicone devices that are permeable to oxygen. In some embodiments, the diffuser comprise a grid and/or serpentine tubing arrangement to increase surface area. In certain embodiments, the fluid delivery channel or conduit 52 comprises an oxygen permeable structure (e.g. silicone) and oxygen concentration is modified or partially controlled by the length of tubing provided (within the body and/or external to the body).

The embodiment of FIG. 3 contemplates that the fluid source and the diffuser are provided external to a patient. However, the present disclosure contemplates that various features of systems of the present disclosure are provided internal or external to a patient. Fluid from the fluid source 42 is delivered to a silicone insert or wafer 46 by a catheter 54. In some embodiments, the catheter 54 comprises a skin-integrating catheter such as those shown and described in U.S. Patent Application Publication No. 2020/0281709 and U.S. patent application Ser. No. 63/337,449, which are hereby incorporated by reference. Such devices are operable to interface with the host in a manner that reduces infection risk and provides various benefits as shown and described in U.S. Patent Application Ser. No. 63/337,449, for example. The silicone wafer 46 is contemplated as comprising a vascularizing membrane including, for example, those shown in U.S. Patent Application Publication No. 2021/0401564, which is hereby incorporated by reference in its entirety.

The system of FIG. 3 further comprises an implantable encapsulation device 48. The device 48 is contemplated as comprising various features and serving various functions. Examples of the implantable encapsulation devices operable for use with the embodiment of FIG. 3 include, for example, those shown and described in U.S. Patent Application Publication No. 2021/0401564.

A terminus of the system comprises a sensor 50a which preferably comprises a pressure sensor. The sensor 50a extends from and is spaced a distance apart from the encapsulation device 48 by a section of conduit 52. The pressure in the conduit 52 and at the sensor 50a is contemplated as reaching a steady state and being substantially the same as the pressure in the remainder of the system after a relatively short amount of time and fluid delivery. The sensor 50a is operable to measure pressure (for example) and communicate with the system in a manner that allows for fluid delivery from the source 42 to be selectively activated and deactivated thereby improving efficiencies, reducing requirements for battery sizing and capacity, reducing the need for a large volumes of stored oxygen (for example) and creating an overall smaller, more portable, safer and more useful system. As shown in FIG. 4, it is also contemplated that at least one additional sensor 50b is provided. The second sensor 50b is shown as not being in fluid communication with the conduit 52. The second sensor 50b is contemplated as measuring a second pressure or a second oxygen concentration at a distance away from the other system components, for example.

FIG. 4 is an elevation view of an implantable system 59 according to one embodiment of the present disclosure. As shown, the system 59 comprises a subcutaneous or partially subcutaneous system operable to be implanted beneath the skin 60 of a patient. The system 59 is contemplated as comprising a fluid source 62. In various embodiments, the fluid source 62 comprises a source of oxygen or oxygenated gas such as an oxygen storage device and/or an oxygen generator. The source 62 is in fluid communication with elements of the system implanted under the skin 60 of a patient via one or more fluid channels 70. The channel 70 is contemplated as comprising a vascularized channel operable to reduce tunnel-site infection. In some embodiments, only a portion 72 of the channel comprises features of a vascularized catheter. In the depicted embodiment, the system comprises an oxygen diffuser 64. The diffuser 64 is shown as an implanted diffuser 64 in FIG. 4. It is contemplated, however, that the diffuser 64 may be external to the system or may be omitted from the system. The diffuser 64 is operable to modify the composition or concentration of the fluid provided from the source 62. In some embodiments, the diffuser 64 reduces a concentration of oxygen in the delivered fluid (e.g. from 100% to between 30% and 80%). An implantable cell encapsulation device 66 is further provided. The device 66 is operable to house and/or receive at least one of cells and therapeutic agents. Although not shown in FIG. 4, the device 66 may be connected to an external source including, for example, an external insulin source. The fluid channel 70 extends from the device 66 and comprises a closed terminus such that the channel 70 and related components comprises a closed system. In preferred embodiments, the channel terminus comprises a sensor 68. In some embodiments, the sensor 68 comprises a pressure sensor 68.

Although various elements of FIG. 4 are not to scale, various embodiments of the present disclosure including that of FIG. 4 provides for a pressure sensor that is located and/or operable to be located proximal to the skin 60 of a patient while also providing the implantable device 66 at a greater depth than the sensor 68.

As further shown in FIG. 4, a sensor 74 is contemplated as being provided with the system 59. The sensor 74 is contemplated in at least some embodiments as comprising a wearable oxygen, a wearable glucose sensor, or a combination thereof provided on the skin 74. The sensor is contemplated as being operable to provide signals to one or more additional devices to evaluate a patient and/or control aspects of the system (e.g. the fluid source 62).

FIG. 5 is a schematic view of a system according to another embodiment of the present disclosure. As shown, the system 40 comprises a fluid source 42. The fluid source is contemplated as comprising one or more of stored gas (e.g. oxygen) and an oxygen generator. The oxygen generator is contemplated as being operable to generate pure oxygen, comprises an adjustable flow-rate, and has a back pressure cut-off feature that is adjustable to terminate fluid flow based on a pressure reading in the system (e.g. downstream in the system).

The fluid source 42 is in fluid communication with a diffuser 44 via oxygen permeable silicone tubing (for example). A diffuser 44 is provided in various embodiments and enables control of oxygen levels to be delivered to other components of the system. For example, it is contemplated that one or more oxygen diffusers are provided to reduce the amount or concentration of oxygen in a fluid from the source 42. Diffusers of the present disclosure including but not limited to those shown in FIG. 5 are contemplated as comprising silicone devices that are permeable to oxygen. In some embodiments, the diffuser comprises a grid and/or serpentine tubing arrangement to increase surface area. In certain embodiments, the fluid delivery channel or conduit 52 comprises an oxygen permeable structure (e.g. silicone) and oxygen concentration is modified or partially controlled by the length of tubing provided (within the body and/or external to the body).

An in-line flow meter 57 and oxygen sensor 59 are provided to monitor a flow rate of fluid from the source 42, measure back-pressure, and/or measure an amount of oxygen being delivered. The flow meter and sensor may comprise a combined device or may comprise separate components.

A silicone wafer 46 is provided and is contemplated as comprising a vascularizing membrane including, for example, those shown in U.S. Patent Application Publication No. 2021/0401564, which is hereby incorporated by reference in its entirety.

The embodiment of FIG. 5 is contemplated as comprising an ex vivo preservation system for an implantable device 48 and/or cells within the device 48.

The system of FIG. 5 further comprises an implantable encapsulation device 48. The device 48 is contemplated as comprising various features and serving various functions. Examples of the implantable encapsulation devices operable for use with the embodiment of FIG. 5 include, for example, those shown and described in U.S. Patent Application Publication No. 2021/0401564. A reader 55 is contemplated as being provided external to the additional components and is operable to detect various parameters from within the system including for example, an oxygen concentration within the encapsulation device 48.

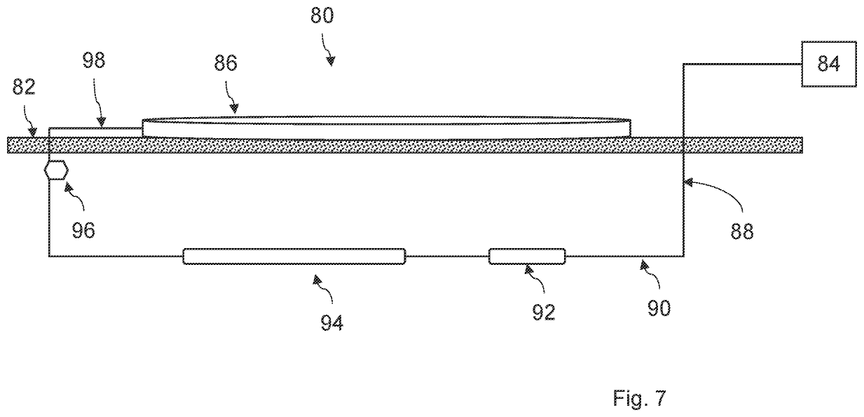

As shown in FIG. 6, a system is provided. The system comprises a fluid supply 22 and a pump 24. Pumps of the present disclosure are contemplated as but are not limited to peristaltic pumps. The fluid supply, which may comprise oxygen gas, is operable to be delivered to one or more organs 26 or tissues to be preserved. Organs contemplated for preservation by systems and methods of the present disclosure include, but are not limited to, pancreases, kidneys, hearts, lungs, etc. As further shown in FIG. 6, a pressure sensor 28 is provided a terminus of the gas supply line 30. The pressure sensor is operable to determine a pressure and, in some embodiments, a related oxygen concentration in the system and selectively activate and deactivate the delivery of fluid from the supply 22. The pressure values that determine when fluid flow is to be activated and terminated are contemplated as varying based on the type of organ, tissue, or device provided with the system. For example, a pancreas is contemplated a certain activation and deactivation levels while a vascularized cell encapsulation device, a kidney, etc. may require the provision and cessation of fluid (e.g. oxygen) at different levels.

The system of FIG. 6 further comprises a bifurcation 32 in a fluid line. The bifurcation is contemplated as comprising a valve to control and direct fluid flow. A fluid line 34 extends from the bifurcation and an in-line sensor 36 is provided. The in-line sensor 36 is contemplated as comprising an oxygen sensor or other type of sensor (e.g. carbon dioxide sensor). No limitation with respect to the specific type of sensor is provided. The fluid line 34 of FIG. 6 further extends to and is in fluid communication with an additional device 38 which in at least some embodiments is contemplated as comprising at least one of a filter and a vent. The device 38 is provided in combination with the fluid line 34 and the bifurcation to optionally and selectively enable pass-through fluid flow of fluid (e.g. oxygenated gas) from the source 22 and/or the vessel 27 in which the organ or tissue resides. The system of FIG. 6 is operable for use in at least two modes wherein a first mode comprises a “dead-end” system operable to detect pressure at the sensor 28 in a closed system and regulate fluid (e.g. oxygen) delivery; and wherein a second mode comprises allowing at least a portion of the fluid flow to be vented and/or exhausted from the vent feature 38.

Various embodiments of the present disclosure comprise highly portable, energy efficient, and resource efficient systems that are operable and useful for travel and transportation. It is also contemplated, however, that such systems and embodiments are also capable of, operable to, and contemplated as being connected or connectable to additional components at least when transportation and efficiency are not of primary concern. For example, portable systems of the present disclosure may be connected to large infrastructure including, for example, oxygen gas supply sources, energy sources, hoods and exhaust systems known to be provided in laboratories, hospitals, and other facilities. Accordingly, systems of the present disclosure that are well suited for travel including but not limited to those shown in FIGS. 1, 2, 5, and 6 can be connected and “plugged in” to another system. Such capabilities may be desirable, for example, after an organ to be preserved has been transported and while it is awaiting transplantation at a hospital facility.

FIG. 7 is a schematic view of a system according to an embodiment of the present disclosure. The system 80 of FIG. 7 comprises a system with improved oxygen delivery features for various locations and purposes. As shown, the system 80 comprises a subcutaneous or partially subcutaneous system operable to be implanted beneath the skin 82 of a patient. The system 80 is contemplated as comprising a fluid source 84. In various embodiments, the fluid source 84 comprises a source of oxygen or oxygenated gas such as an oxygen storage device and/or an oxygen generator. The source 84 is in fluid communication with elements of the system implanted under the skin 82 of a patient via one or more fluid channels 90. The channel 90 is contemplated as comprising a vascularized channel operable to reduce tunnel-site infection. In some embodiments, only a portion 88 of the channel comprises features of a vascularized catheter. In the depicted embodiment, the system comprises an oxygen diffuser 92. The diffuser 92 is shown as an implanted diffuser 92 in FIG. 7. It is contemplated, however, that the diffuser 92 may be external to the system or may be omitted from the system. The diffuser 92 is operable to modify the composition or concentration of the fluid provided from the source 84. In some embodiments, the diffuser 92 reduces a concentration of oxygen in the delivered fluid (e.g. from 100% to between 30% and 80%). An implantable cell encapsulation device 94 is further provided. The device 94 is operable to house and/or receive at least one of cells and therapeutic agents. Although not shown in FIG. 7, the device 94 may be connected to an external source including, for example, an external insulin source. The fluid channel 90 extends from the device 94. In the depicted embodiment, the channel 90 extends from the device 94, exist the skin 82 and comprises a fluid conduit 98 for providing fluid (e.g. oxygen) to a wound dressing 86. The wound dressing 86 is contemplated as comprising various features for various purposes including but not limited to protecting and promoting healing of the implantation site and surgical wound related to the system itself (e.g. implantable components). The wound dressing 86 is contemplated as comprising, for example, one or more devices shown and described in: U.S. Pat. No. 10,632,018 to Wells et al., U.S. Patent Application Publication No. 2016/0000611 to Niederauer et al., and U.S. Patent Application Publication No. 2022/0193326 to Niederauer et al., the entireties of which are hereby incorporated by reference for all purposes. The provision of oxygen or other therapeutic fluid(s) of FIG. 7 provided various benefits to the viability of the implantable device and to the wound or surgical site to be treated at the skin level via the device 86.

The system of FIG. 7 is contemplated as comprising various sensors at various locations including, for example, a sensor 96. The sensor 74 is contemplated in at least some embodiments as comprising an oxygen sensor between the implantable device 94 and the wound care device 86. The sensor is contemplated as being operable to provide signals to one or more additional devices to evaluate a patient and/or control aspects of the system (e.g. the fluid source 84).

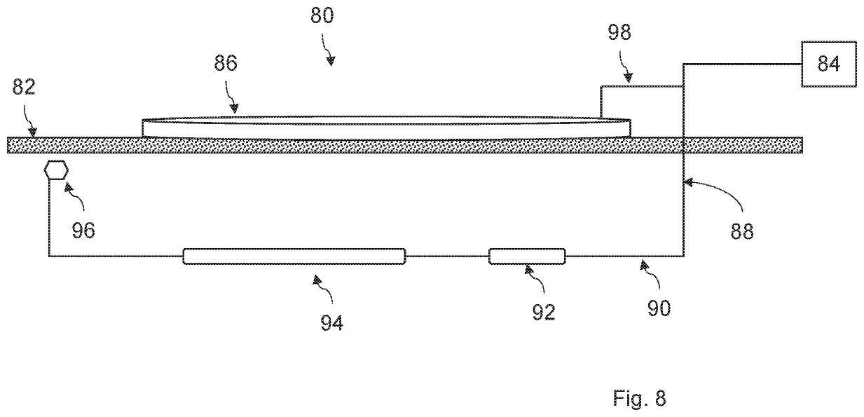

FIG. 8 is a schematic of a system 80 that is similar to the embodiment of FIG. 7 and comprises various features shown and described with respect to FIG. 7. FIG. 8 illustrates an alternative fluid delivery system wherein the fluid source 84 comprises a channel to deliver fluid to the implanted structures and a bifurcation and conduit 98 to provide fluid to the wound care device 86. The conduit 98 does not extend beneath the skin. A valve may be provided to selectively provide fluid to the subcutaneous 88 and/or supracutaneous 98 conduit(s). embodiments of the present disclosure further contemplate one or more filters provided at the inlet and outlet of the channel(s) relative to the skin to ensure sterility of gas before being delivered to an intended target.

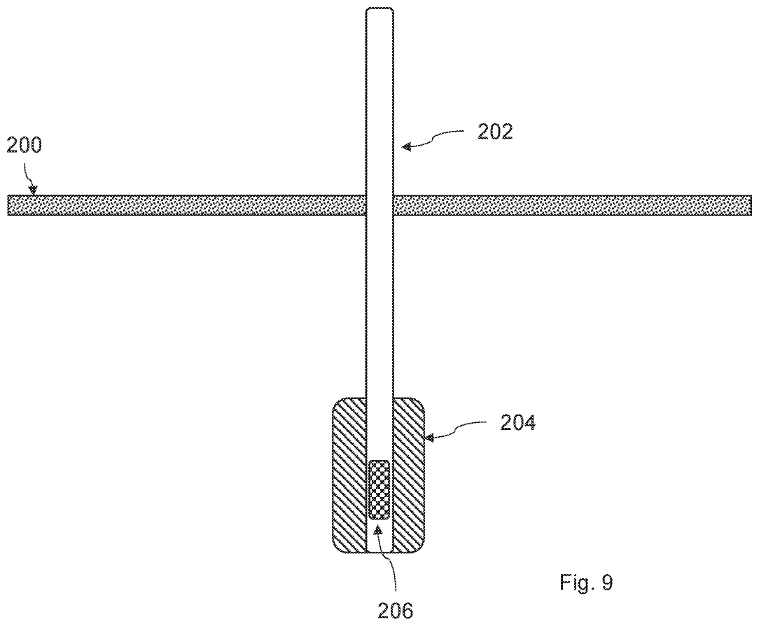

FIG. 9 depicts an embodiment of the present disclosure comprising an implantable chamber 204 at a subcutaneous location with the skin 200 of a patient provided for reference. The chamber 204 preferably comprises a vascularized chamber that is operable to receive at least one of a sensor, cells, and therapeutic agent(s). A conduit 202 is provided that is operable to provide an implantation pathway. The conduit 202 is contemplated as comprising various features including, for example, a vascularized catheter as shown and described herein, a selectively connectable conduit, and similar features. FIG. 9 depicts a cartridge 206 provided in the implantable device and wherein the cartridge 206 is implantable via the conduit 202. The cartridge 206 is contemplated as comprising at least one of a sensor, cells, and a therapeutic agent.

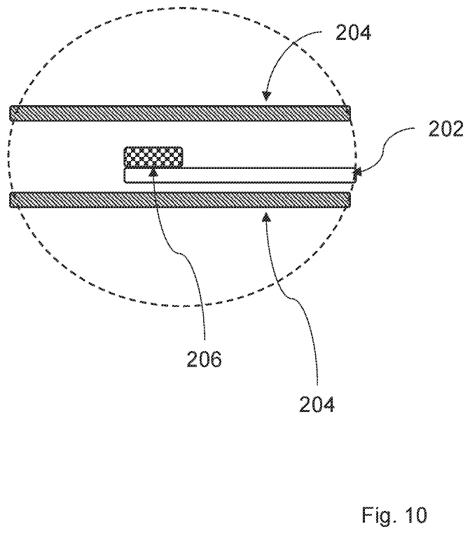

FIG. 10 is a cross-sectional elevation view of the embodiment of FIG. 9. As shown, a cartridge 206 is provided within a vascularized chamber comprising at least one membrane or vascularized layer 204. The cartridge is contemplated as being implantable and extractable via the conduit 202.

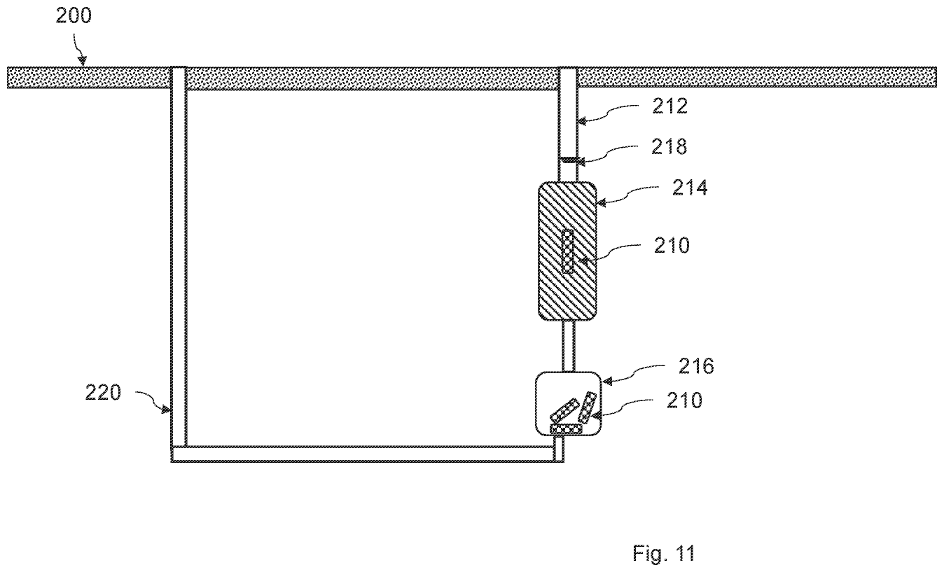

FIG. 11 is an illustration of a system according to an embodiment of the present disclosure. The system comprises an implantable system that is operable to receive one or more sensors 210. As shown, the system comprises a subcutaneous conduit or channel 212 that extends beneath the skin 200. A chamber 214 is preferably provided beneath the skin and the chamber 214 is operable to receive at least one sensor 210 via the conduit 212. Sensors contemplated for use with the present disclosure (including but not limited to the embodiment of FIG. 11) and to be provided within the system are contemplated as comprising various different types of sensors for various different purposes. The sensors, for example, are contemplated as comprising electrochemical sensors, NMR sensors, optical sensors and similar devices and are operable to sense, detect or evaluate one or more of oxygen levels, glucose levels, temperature, etc. Implantable sensors as contemplated for use with the depicted embodiment are known to comprise a finite lifespan that is generally shorter than the lifespan of an implantable system. Accordingly, sensors will require removal and/or replacement during the life of the system in order to continue to monitor conditions associated with the system.

The system of FIG. 11 comprises a chamber 214 for receiving a working sensor 210. A sensor collection feature or repository 216 is provided in series with the chamber 214. The repository 216 is operable to receive spent or used sensors that are no longer functional. Sensors 210 are collected in the repository in a manner that reduces the need or frequency at which surgical procedures must be performed to remove the sensors 210. Existing systems and methods contemplate some level of invasive surgery to remove and/or replace a sensor upon sensor expiration. The present disclosure and the embodiment of FIG. 11 provide for a significantly reduced need for such procedures wherein sensors 210 may be “pushed” or forced into the chamber or repository 216 and housed therein until a removal operation is performed. Such features and systems reduce the need for surgical intervention where, for example, removal procedures are required on the order of months of years as opposed to weeks.

FIG. 11 depicts one physical arrangement of components wherein the repository 216 is provided below and at a greater subcutaneous depth than the chamber 214. It will be recognized, however, that the present disclosure is not limited to such an arrangement. It is contemplated, for example, that the repository may be provided at the same depth as the chamber 214. The repository may be provided at various subcutaneous depths and, in some embodiments, is provided proximal to the skin 200 to facilitate sensor removal operations.

The embodiment of FIG. 11 further comprises a sensor activation feature 218. In some embodiments, it is contemplated that new or unused sensors initially comprise a film or seal that must be removed in order to activate the sensor. Embodiments of the present disclosure, including but not limited to FIG. 11, contemplate a structural member that scrapes or removes the film prior to the sensor entering the chamber 214 and wherein the sensor is automatically activated as it is transmitted through the channel 212. In alternative embodiments, a chemical means is provided in addition to or in lieu of the activation feature 218. For example, in some embodiments, the sensors are initially provided with an alginate coating that is to be removed prior to use. Embodiments and systems of the present disclosure contemplate the provision of an agent (e.g. sodium citrate) to dissolve and remove the alginate barrier and activate the sensor(s).

The embodiment of FIG. 11 contemplates and depicts a removal conduit 220 for sensors. As shown, the removal conduit extends from the repository 216 to the skin 200 or a location just below the skin. While certain embodiments of the present disclosure are devoid of the depicted removal conduit and rely solely on surgical or manual removal of the sensors directly from the repository 216, further embodiments comprise a pathway 220 for transmitting used or expired sensors from the body.

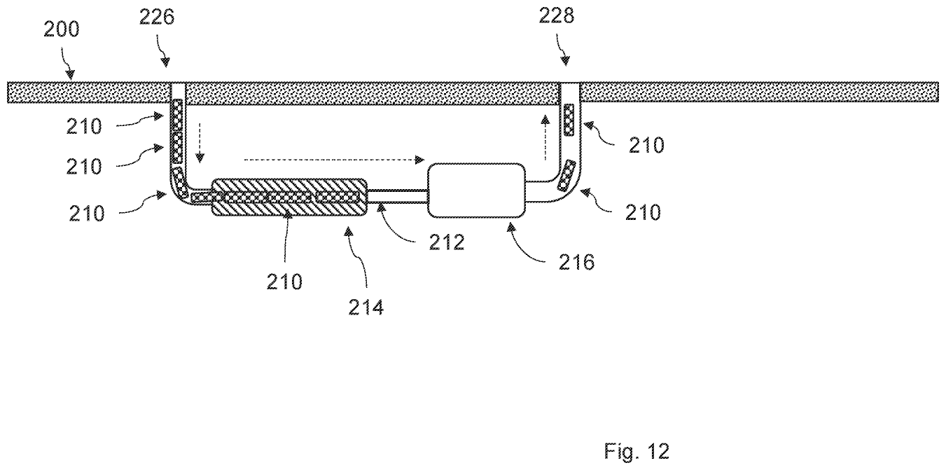

FIG. 12 illustrates an implantable system according to an embodiment of the present disclosure. As shown, the system comprises a pathway for a series of sensors 210. The sensors 210 are contemplated as being provided in series and, in some embodiments, are provided in an adjacent or stacked arrangement and are provided to a chamber 214 as needed. Accordingly, a force applied to a sensor 210 is operable to be transmitted to an adjacent sensor 210. Sensors are moved into and out of a chamber 214 in series and spent or expired sensors are moved out of the chamber and provided to a repository 216 and/or removed from the patient.

Embodiment of the present disclosure contemplate that an activated sensor is provided to the chamber 214 and is useful for approximately 3-6 months or longer. Once used and/or expired, the sensor is displaced from the chamber by new, adjacent sensor(s).

Although the embodiments of the present disclosure depict sensors provided to a subcutaneous system, it is contemplated that systems and features of the present disclosure contemplate cartridge, cells, therapeutic agents, and similar features in place of various sensors as shown in FIGS. 11-12 (for example).

The examples set forth above are provided to give those of ordinary skill in the art a complete disclosure and description of how to make and use the embodiments of the methods for prediction of the selected modifications that may be made to a biomolecule of interest, and are not intended to limit the scope of what the inventors regard as the scope of the disclosure. Modifications of the above-described modes for carrying out the disclosure can be used by persons of skill in the art, and are intended to be within the scope of the following claims.

It is to be understood that the disclosure is not limited to particular methods or systems, which can, of course, vary. It is also to be understood that the terminology used herein is for the purpose of describing particular embodiments only, and is not intended to be limiting.

A number of embodiments of the disclosure have been described. Nevertheless, it will be understood that various modifications may be made without departing from the spirit and scope of the present disclosure. Accordingly, other embodiments are within the scope of the following claims.

What is claimed is:

1. A system for maintaining and preserving at least one of an organ, a tissue and an implantable therapeutic device, the system comprising:
a fluid delivery system comprising a fluid source and a fluid conduit;
wherein the fluid conduit supplies fluid to at least one of an organ, a tissue, and an implantable therapeutic device;
wherein the fluid conduit extends from the at least one of an organ, a tissue, and an implantable therapeutic device and comprises a closed terminus;
a pressure sensor operable to determine a pressure and a controller operable to terminate fluid delivery from the fluid delivery system when the pressure determined by the pressure sensor is equal to or greater than a predetermined value.

2. The system of claim 1, further comprising a thermal control system operable to modify or control a temperature of the fluid.

3. The system of claim 2, wherein the thermal control system is provided within a vessel operable to house the at least one of an organ, a tissue, and an implantable therapeutic device.

4. The system of claim 1, wherein the fluid source comprises oxygen gas.

5. The system of claim 1, wherein the at least one of an organ, a tissue, and an implantable therapeutic device comprises an implantable therapeutic device;
wherein the implantable therapeutic device is implanted at a first subdermal depth and the pressure sensor is provided at a second subdermal depth; and
wherein the first subdermal depth is greater than the second subdermal depth.

6. A method of preserving at least one organ ex vivo, the method comprising the steps of:
providing the at least one organ with a flow of fluid and wherein the fluid comprises oxygen;
monitoring at least one of pressure and oxygen concentration in the system; and
selectively activating and/or deactivating the flow of fluid based on the at least one of pressure and oxygen concentration.
